(19) United States
(12) Patent Application Publication
(10) Pub. No.: US 2004/0258816 A1
(43) Pub. Date: Dec. 23, 2004

(54) Process for treating a liquid

(76) Inventor: Danny D. Smallwood, Gainesville, GA (US)

Correspondence Address: Thomas A. Hodge, Baker, Donelson, Bearman,, Caldwell & Berkowitz, Five Concourse Parkway, Suite 900, Atlanta, GA, 30328, US

(21) Appl. No.: 10/825,017

(22) Filed: Apr. 15, 2004

Related U.S. Application Data
(60) Provisional application No. 60/464,389, filed on Apr. 18, 2003.

(51) Int. Cl. A23P 1/00

(52) U.S. Cl. 426/490

(57) ABSTRACT

A liquid from a process step in a food processing plant is treated with chlorine (if the liquid is water) and filtered to remove contaminants.

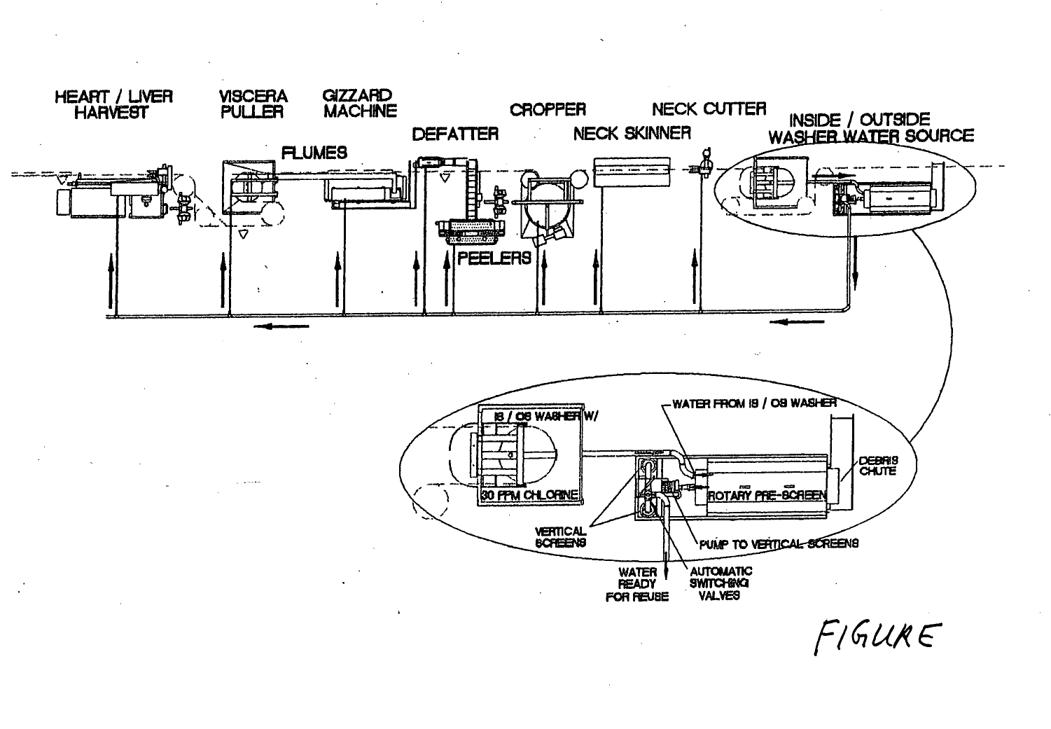

This application claims the benefit of U.S. Provisional Patent Application Ser. No. 60/464,389, filed Apr. 18, 2003.

### TECHNICAL FIELD

The present invention relates to a process for treating a liquid. In a more specific aspect, this invention relates to a process for treating a liquid to remove contaminants.

In this application, the term “liquid” generally refers to a liquid material, such as water, which has been used in a food industry process and which contains contaminants as a result of such use.

In this application, the term “contaminants” generally refers to the materials which must either be removed from a liquid or at least removed in a sufficient quantity so that the treated liquid (i.e., the effluent) can be reused in food industry processes. Examples of such contaminants are meat, skin, organs, grit, etc.

This invention will be described with specific reference to water as the liquid being treated. However, this invention should be understood as useful to remove contaminants from other liquids which have been used in food industry processes.

### BACKGROUND OF THE INVENTION

In the food industry, such as in a poultry processing plant, water is commonly used in a variety of process steps. For economical, efficiency and environmental concerns, the plant operator desires to reuse the water from one process step in the same or a different process step.

However, at present, reuse is generally not possible as the water after a process step contains contaminants which could adversely affect other process steps.

Various methods have been proposed for treating water to remove contaminants, but these methods are generally directed to the municipal requirements for discharging water into municipal sewer systems.

Therefore, there is a need for a process that effectively treats a liquid after being used in a process step so that such liquid can be reused in either the same process step or a different process step.

### SUMMARY OF THE INVENTION

In the present invention, a liquid which has been used in a process step is treated so that the subsequent treated liquid can be reused in either the same or a different process step.

Although the present invention is believed to have utility for treating all types of liquids, the present invention is especially useful in treating water between process steps in a food processing plant.

Briefly described, the present invention treats water from a process step by first contacting the water with chlorine and then subjecting the water to filtration to remove contaminants. The treated water can then be reused in the same or other process steps.

The process of this invention removes all or at least substantially all of the contaminants (i.e., solids).

Accordingly, an object of this invention is to provide a process for treating a liquid discharged from a process step.

Another object of this invention is to provide a process for treating a liquid to remove contaminants.

Another object of this invention is to provide a process for treating a liquid so that the liquid can be reused in the same or a different process step.

Still another object of this invention is to provide a process for treating water discharged from a process step.

Still another object of this invention is to provide a process for treating water to remove contaminants.

Still another object of this invention is to provide a process for treating water so that the water can be reused in the same or a different process step.

These and other objects, features and advantages of this invention will become apparent from the following detailed description.

### BRIEF DESCRIPTION OF THE DRAWING

The FIGURE is a partial flow chart of a chicken processing plant in which a preferred embodiment of the present invention is illustrated.

### DETAILED DESCRIPTION OF THE INVENTION

The present invention provides a process for treating a liquid, such as water, to remove contaminants, wherein the process comprises subjecting the liquid to one or more filtration steps. By this process, contaminants are at least substantially removed from the liquid.

In this invention, the liquid is first treated with chlorine if the liquid is water. If the liquid is not water but, for example, is a brine such as from an injection step, the chlorination step is not necessary.

The starting liquid for this process is the liquid which is discharged from a process step in a food processing plant. For example, this could be the step in which a chicken is washed inside and outside.

If the liquid is water, varying amounts of chlorine can be used, depending on the characteristics of the water being discharged. Generally, a range of about 30 ppm to about 50 ppm of chlorine is effective for this invention. Especially good results are obtained at about 30 ppm of chlorine.

Following chlorination (if water), the liquid is moved through one or more filtrations, which can be accomplished with rotary pre-screen filters, vertical screens, etc. Specific filtration means are well known.

The following example is provided to illustrate the process of this invention:

### EXAMPLE

Water being discharged from an inside/outside chicken washer is treated with 30 ppm of chlorine and then filtered through a rotary pre-screen filter, followed by filtration though a series of vertical screens. The chlorinated/filtered water shows the following characteristics:

| | |
|---|---|
| E. coli | less than 10 |
| Total coliforms | less than 10 |
| Total plate count | less than 10 |
| Salmonella | negative |

The chlorinated/filtered water is suitable for use in other areas of the chicken processing plant, such as evisceration.

This invention has been described in detail with particular reference to certain embodiments, but variations and modifications can be made without departing from the spirit and scope of the invention as defined in the following claims.

What is claimed is:

1. A process for treating a liquid from a process step in a food processing plant, wherein the process comprises filtering the liquid, wherein substantially all contaminants are removed from the liquid.

2. A process for treating water from a process step in a food processing plant, wherein the process comprises chlorinating the water and then filtering the chlorinated water, wherein substantially all contaminants are removed from the water.
